(19) United States
(12) Patent Application Publication
(10) Pub. No.: US 2010/0215992 A1
(43) Pub. Date: Aug. 26, 2010

(54) SINGLE-SIDED PERPENDICULAR MAGNETIC RECORDING MEDIUM

(75) Inventors: Junichi HORIKAWA, Tokyo (JP); Kenji AYAMA, Singapore (SG); Masafumi ISHIYAMA, Singapore (SG); Toshikatsu YAMAGUCHI, Shinjuku-ku (JP); Yusuke SETO, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: HOYA CORPORATION, Tokyo (JP); HOYA MAGNETICS SINGAPORE PTE. LTD., Singapore (SG)

(21) Appl. No.: 12/709,845

(22) Filed: Feb. 22, 2010

(30) Foreign Application Priority Data
Feb. 23, 2009 (JP) 2009-039432
Feb. 19, 2010 (JP) 2010-034300

(51) Int. Cl. G11B 5/706

(52) U.S. Cl. 428/846.7; 428/846; 428/846.6; 428/846.8; 428/846.9

(57) ABSTRACT

A magnetic recording medium used for perpendicular magnetic recording, the magnetic recording medium comprising: a substrate having a first surface and a second surface opposite to the first surface; a magnetic recording medium constituent layer formed on the first surface of the substrate, the magnetic recording medium constituent layer including at least a magnetic recording layer; a non-magnetic metal film formed on the second surface of the substrate; and a carbon-based protective film formed on the non-magnetic metal film.

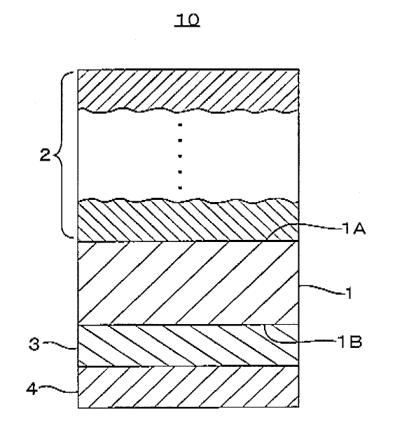

This application is based upon and claims the benefit of priority from Japanese Patent Application No. 2009-039432, filed on Feb. 23, 2009, and Japanese Patent Application No. 2010-034300, filed on Feb. 19, 2010, the disclosures of which are incorporated herein in their entirety by reference.

### BACKGROUND

1. Field of the Invention

The present invention relates to a perpendicular magnetic recording medium mounted on a magnetic disk device such as a perpendicular magnetic recording type hard disk drive (HDD).

2. Description of the Related Art

Various information recording techniques have been developed along with recent increase of capacity in information processing. Particularly, the areal recording density of hard disk drives (HDDs) using a magnetic recording technique has continued to increase at an annual rate of about 100%. Recently, a 2.5-inch magnetic recording medium used for an HDD or the like has been required to have an information storage capacity greater than 250 Gbytes per disk. In order to meet such a demand, it is necessary to achieve an information recording density greater than 400 Gbits/inch². In order to achieve a high recording density of a magnetic disk used for an HDD or the like, it is necessary to reduce the size of magnetic crystal grains that constitute a magnetic recording layer, which is used to record informational signals, and to reduce the thickness of the magnetic recording layer. As a result of development in reduction of the size of magnetic crystal grains, however, the thermal stability of recorded signals is deteriorated due to the superparamagnetism phenomenon in an in-plane magnetic recording type magnetic disk, which has heretofore been commercialized. Therefore, the recorded signals are lost, and a thermal fluctuation phenomenon occurs. Those problems inhibit an increase of the recording density of a magnetic disk. The in-plane magnetic recording type is also referred to as a longitudinal magnetic recording type or a horizontal magnetic recording type.

In order to eliminate those inhibitors, a perpendicular magnetic recording type magnetic disk has been proposed in recent years. Unlike an in-plane magnetic recording type magnetic disk, a perpendicular magnetic recording type magnetic disk has a magnetic recording layer with an easy axis oriented perpendicular to a surface of a substrate. The perpendicular magnetic recording type can reduce a thermal fluctuation phenomenon as compared to the in-plane magnetic recording type. Therefore, the perpendicular magnetic recording type is suitable to increase the recording density, For example, JP-A-2002-92865 (Patent Document 1) discloses a technique relating to a perpendicular magnetic recording medium including an underlayer, a Co-based perpendicular magnetic recording layer, and a protective layer formed in the order named. Furthermore, U.S. Pat. No. 6,468,670 (Patent Document 2) discloses a perpendicular magnetic recording medium having a structure to which an artificial lattice film continuous layer (exchange coupling layer) that has been exchange-coupled to a particulate recording layer is attached.

Drastic improvement in recording density has developed applications of magnetic disks such that the magnetic disks can meet desired requirements only with a capacity of a single side of a substrate. Those applications are expected to expand more widely. Thus, the market has strongly demanded cost reduction of such single-sided media.

General magnetic recording media are double-sided with magnetic recording medium constituent layers being formed on both surfaces of a substrate. Therefore, cost can be reduced with a single-sided medium having a magnetic recording medium constituent layer formed on one surface of a substrate. However, the inventors have found that, although single-sided media having a magnetic recording medium constituent layer formed on one surface of a substrate can reduce the cost, the magnetic characteristics and the reliability characteristics, which are very important, are inferior to those of double-sided media. The inventors have also found that the flatness is deteriorated by warping of the substrate. Furthermore, in a case where a glass substrate is used, alkali metals such as lithium, sodium, and potassium as glass components cannot be prevented from being eluted from a portion on which no magnetic recording medium constituent layer is formed. Therefore, a single-sided medium having a simple structure cannot be used as a practical product.

JP-A-2005-85339 (Patent Document 3) discloses a magnetic recording medium comprising a substrate for a magnetic recording medium, which includes a primary substrate having a base surface and a secondary substrate formed on the base surface by a deposition technique such as a bias sputtering method of applying a bias power to the base surface. The magnetic recording medium further comprises a recording layer directly or indirectly formed on the secondary substrate.

According to the inventors' study, the magnetic recording medium disclosed in Patent Document 3 suffers from the following problems:

1. Due to a difference in film thickness between the primary substrate and the secondary substrate, differences are produced in magnetic characteristics and electromagnetic characteristics as compared with a conventional double-sided medium.

2. When a reliability test is performed in an atmosphere having a high humidity, corrosion spots are observed due to components of the magnetic recording layer or components of the glass substrate.

3. If a deposition process of the secondary substrate is different from that of the primary substrate, then the substrate is likely to warp.

4. Depending upon the film thickness of the secondary substrate, arc discharge is likely to be produced when a bias is applied during the deposition. In such a case, the disk is deformed, so that the deposition cannot be completed. Furthermore, the arc discharge causes troubles to a sputtering apparatus.

### SUMMARY

The present invention has been made in view of the above drawbacks of the conventional single-sided media. It is, therefore, an object of the present invention to provide a single-sided perpendicular magnetic recording medium that can exhibit magnetic characteristics and reliability characteristics that are almost equivalent to those of conventional double-sided media and can remarkably reduce the cost.

In order to attain the above object, the present invention has the following structures:

(Structure 1)

A magnetic recording medium used for perpendicular magnetic recording, the magnetic recording medium comprising:

a substrate having a first surface and a second surface opposite to the first surface;

a magnetic recording medium constituent layer formed on the first surface of the substrate, the magnetic recording medium constituent layer including at least a magnetic recording layer;

a non-magnetic metal film formed on the second surface of the substrate; and

a carbon-based protective film formed on the non-magnetic metal film.

(Structure 2)

The magnetic recording medium according to the structure 1, wherein the non-magnetic metal film is formed of a material containing, as a principal component, one element of Cr, Ti, Ta, W, Mo, and Al or a compound of two or more elements of Cr, Ti, Ta, W, Mo, and Al.

(Structure 3)

The magnetic recording medium according to the structure 1 or 2, wherein the non-magnetic metal film has a film thickness in a range of from 10 nm to 100 nm.

(Structure 4)

The magnetic recording medium according to the structure 1 to 3, wherein the carbon-based protective film comprises a diamond-like carbon film.

(Structure 5)

A single-sided perpendicular magnetic recording medium according to any one of the structures 1 to 4, wherein the substrate is a glass substrate.

(Structure 6)

The magnetic recording medium according to any one of the structures 1 to 5, wherein the magnetic recording layer includes a ferromagnetic layer having a granular structure which includes crystal grains mainly formed by cobalt (Co) and boundaries mainly formed by oxides.

According to the present invention, it is possible to provide a single-sided perpendicular magnetic recording medium that can exhibit magnetic characteristics and reliability characteristics that are almost equivalent to those of conventional double-sided media and can remarkably reduce the cost.

The above and other objects, structures, and advantages of the present invention will be apparent from the following description when taken in conjunction with the accompanying drawings which illustrate preferred embodiments of the present invention by way of example.

### BRIEF DESCRIPTION OF THE DRAWINGS

The sole FIGURE is a cross-sectional view schematically showing a single-sided perpendicular magnetic recording medium according to an embodiment of the present invention.

### DETAILED DESCRIPTION OF THE PREFERRED EMBODIMENTS

An embodiment of the present invention will be described in detail below.

A single-sided perpendicular magnetic recording medium according to the present invention is used for perpendicular magnetic recording. The magnetic recording medium includes a substrate having a first surface and a second surface opposite to the first surface. The magnetic recording medium also includes a magnetic recording medium constituent layer formed on the first surface of the substrate. The magnetic recording medium constituent layer includes at least a magnetic recording layer. The magnetic recording medium includes a non-magnetic metal film formed on the second surface of the substrate and a carbon-based protective film formed on the non-magnetic metal film.

The sole FIGURE is a cross-sectional view showing a single-sided perpendicular magnetic recording medium 10 according to an embodiment of the present invention. According to the embodiment shown in the sole FIGURE, the single-sided perpendicular magnetic recording medium 10 includes a substrate 1 and a magnetic recording medium constituent layer 2 formed on a base surface (primary surface) 1A of the substrate 1. The magnetic recording medium constituent layer 2 includes at least a magnetic recording layer. The single-sided perpendicular magnetic recording medium 10 also includes a non-magnetic metal film 3 formed on a secondary surface 1B of the substrate 1, which is opposite to the base surface 1A, and a carbon-based protective film 4 formed on the non-magnetic metal film 3.

A glass substrate is preferably used for the substrate 1, which will be described in detail later.

The magnetic recording medium constituent layer 2 is a perpendicular magnetic recording medium constituent layer. For example, an adhesive layer, a soft magnetic layer, a seed layer, an underlayer, a magnetic recording layer (perpendicular magnetic recording layer), a protective layer, a lubricating layer, and the like are stacked in the order named as the magnetic recording medium constituent layer 2 on the substrate 1.

For example, a material containing, as a principal component, one element of Cr, Ti, Ta, W, Mo, and Al or a compound of two or more elements of Cr, Ti, Ta, W, Mo, and Al is preferably used for the non-magnetic metal film 3 formed on the secondary surface 1B of the substrate 1. These elements are preferable because of high adhesion with a glass substrate and a carbon-based protective layer and of high chemical stability against oxidization or the like. Combination of some of these elements is more preferable because a dense amorphous film can be obtained. For example, CrTi, CrMo, or CrTa is preferably used as a compound of two or more elements of Cr, Ti, Ta, W, Mo, and Al.

In the case where CrTi is used for the non-magnetic metal film 3, it is preferable in view of forming the amorphous film to set a compositional ratio of Cr and Ti such that Cr:Ti=10:90 to 70:30 in atomic percentage.

The non-magnetic metal film 3 may be formed, for example, by sputtering with a supply power of 100 W to 1,000 W).

The film thickness of the non-magnetic metal film 3 is preferably in a range of 10 nm to 100 nm, more preferably in a range of 30 nm to 60 nm. If the film thickness of the non-magnetic metal film 3 is less than 10 nm, the magnetic characteristics and the reliability characteristics are unlikely to be substantially equivalent to those of conventional double-sided media. Additionally, a disk may be broken or chipped by production of bias arc when a substrate bias process such as a CVD protective film is used. Therefore, the film thickness less than 10 nm is not preferable. Meanwhile, if the film thickness of the non-magnetic metal film 3 is greater than 100 nm, the flatness may be deteriorated in some cases. If the film thickness is equal to or greater than 150 nm, the productivity is lowered because of the excessively large thickness.

An amorphous diamond-like carbon film is suitable for the carbon-based protective film 4 formed on the non-magnetic metal film 3. Particularly, a hydrogenated-carbon-based protective film is suitable for the protective film 4. For example, the carbon-based protective film 4 can be formed by a plasma CVD method. According to the present invention, the film thickness of the carbon-based protective film 4 is not limited to specific values. Nevertheless, the film thickness of the carbon-based protective film 4 is preferably in a range of about 1 nm to 10 nm, more preferably in a range of about 2 nm to 5 nm.

According to a single-sided perpendicular magnetic recording medium of the present invention, the non-magnetic metal film is formed on the secondary surface of the substrate. Therefore, excellent magnetic characteristics and reliability characteristics that are almost equivalent to those of conventional double-sided media can be obtained. Additionally, since the magnetic recording layer, which contains an expensive material of noble metal, is formed on only one surface of the substrate, cost can remarkably be reduced. Furthermore, according to a single-sided perpendicular magnetic recording medium of the present invention, deterioration of the flatness due to warping of the substrate is prevented because the non-magnetic metal film is formed on the secondary surface of the substrate. Moreover, a deposition method such as a bias sputtering method of applying a bias voltage can be employed. Additionally, elution of glass components can be prevented in a case where a glass substrate is used.

Examples of glass for the substrate 1 include aluminosilicate glass, aluminoborosilicate glass, and soda lime glass. Among other things, aluminosilicate glass is suitably used for the substrate 1. Furthermore, amorphous glass or crystallized glass may be used. It is preferable to use amorphous glass for the substrate in a case where the soft magnetic layer is amorphous. It is also preferable to use chemically strengthened glass because it has high stiffness. In the present invention, the surface roughness of the primary surface of the substrate is preferably set such that Rmax≦3 nm and Ra≦0.3 nm.

A perpendicular magnetic recording layer is suitably used as the magnetic recording layer formed on the base surface (primary surface) 1A of the substrate 1 because it is effective to increase the recording density. The magnetic recording layer preferably includes a ferromagnetic layer having a granular structure including crystal grains primarily containing cobalt (Co) and grain boundaries primarily containing an oxide of Si, Ti, Cr, Co, Zr, V, Ta, W, and the like.

Specifically, the Co-based magnetic material for the ferromagnetic layer preferably has an hcp crystal structure which is formed by using a target made of a hard magnetic material of CoCrPt (cobalt-chromium-platinum), CoCr (cobalt-chromium), or CoPt (cobalt-platinum) containing at least one of the aforementioned oxides, such as silicon oxide (SiO₂) and titanium oxide (TiO₂), which are non-magnetic materials. Furthermore, the film thickness of the ferromagnetic layer is preferably equal to or less than 20 nm.

In the above-mentioned magnetic recording layer, an auxiliary recording layer is preferably formed above the ferromagnetic layer. By forming the auxiliary recording layer, it is possible to control an exchange energy between magnetic grains in the ferromagnetic layer. Thus, high heat resistance of the auxiliary recording layer can be obtained in addition to high-density recording characteristics and low noise characteristics of the magnetic recording layer. For example, the auxiliary recording layer may have composition of a CoPt-based alloy such as CoCrPtB.

Furthermore, an exchange coupling control layer is preferably formed between the perpendicular magnetic recording layer and the auxiliary recording layer. The exchange coupling control layer allows the strength of exchange coupling between the perpendicular magnetic recording layer and the auxiliary recording layer (continuous layer) to be controlled suitably for optimization of the recording and reproducing characteristics. For example, Ru is preferably used for the exchange coupling control layer.

The perpendicular magnetic recording layer including the ferromagnetic layer is preferably formed by a sputtering method. Particularly, a DC magnetron sputtering method is preferable because the perpendicular magnetic recording layer can be formed uniformly.

The soft magnetic layer for suitably controlling a magnetic circuit of the perpendicular magnetic recording layer on the substrate is configured to have antiferro-magnetic exchange coupling (AFC) by providing a non-magnetic spacer layer between a first soft magnetic layer and a second soft magnetic layer. Thus, magnetization directions of the first soft magnetic layer and the second soft magnetic layer can be arranged and fixed antiparallel to each other with high accuracy. Therefore, noise produced from the soft magnetic layer can be reduced. For example, CoTa-based compounds, CoZr-based compounds, CoNb-based compounds, FeAlSi-based compounds, or CoFe-based compounds, which are typically used for an AFC structure, or ternary or quaternary compounds produced from combinations of those compounds are used for the first soft magnetic layer and the second soft magnetic layer. Additional elements may be mixed to improve the magnetic permeability, the corrosion resistance, and the flatness. Furthermore, Al, Mg, Ti, Cr, and the like may be added to promote an amorphous structure. Moreover, materials for an antiferro-magnetic bias coupling structure, such as FeMn, IrMn, and PtMn, or hard magnetic materials may be used for fixing magnetization. Specifically, the composition of the first soft magnetic layer and the second soft magnetic layer may be CoTaZr (cobalt-tantalum-zirconium), CoFeTaZr (cobalt-iron-tantalum-zirconium), or CoFeTaZrAl (cobalt-iron-tantalum-zirconium-aluminum). The spacer layer may be formed of Ru (ruthenium) or Ru oxide. Additional elements may be mixed to control an exchange coupling coefficient.

It is preferable to provide a non-magnetic underlayer on the substrate for orienting the crystals of the perpendicular magnetic recording layer to be perpendicular to the surface of the substrate. For example, it is preferable to use Ru or alloy of Ru for the non-magnetic underlayer. The non-magnetic underlayer of Ru is preferable because it can exhibit large effects on controlling a crystal axis (c axis) of a CoPt-based perpendicular magnetic recording layer having an hcp crystal structure to be oriented in a perpendicular direction.

It is preferable to form, on the soft magnetic layer, a seed layer having a function of controlling orientation, crystallinity, and separation of crystal grains of the underlayer as an upper layer formed thereon. The material of the seed layer may be selected from Ni, Cu, Pt, Pd, Zr, Hf, and Nb. Furthermore, the material may be an alloy comprising the above-mentioned metal as a main component and one of more additional elements selected from Ti, V, Ta, Cr, Mo, and W. For example, among others, a NiW alloy having a fcc crystal structure is preferable because of an excellent effect of improving the crystallinity of the Ru underlayer as the upper layer. The seed layer desirably has a minimum thickness required to control the crystal growth of the underlayer.

It is preferable to form an adhesive layer between the substrate and the soft magnetic layer. The adhesive layer can improve adhesiveness between the substrate and the soft magnetic layer. Therefore, the soft magnetic layer is prevented from being peeled off. For example, a material containing Cr or Ti may be used for the adhesive layer.

It is preferable to form a protective layer on the perpendicular magnetic recording layer. The protective layer can protect a surface of the magnetic disk from a magnetic head flying above the magnetic recording medium. For example, a carbon-based protective layer may be used for the protective layer. Furthermore, the film thickness of the protective layer is preferably in a range of about 2 nm to about 5 nm.

Furthermore, it is preferable to form a lubricating layer on the protective layer. The lubricating layer can prevent wear caused between the magnetic head and the magnetic disk and can improve the durability of the magnetic disk. For example, it is preferable to use a perfluoropolyether (PFPE) compound for the lubricating layer. For example, the lubricating layer can be formed by a dip coating method.

### Examples

The present invention will be described in greater detail with some examples and comparative examples.

### Example 1

Amorphous aluminosilicate glass was formed into a circular plate by direct pressing. Thus, a glass disk was produced. Grinding, polishing, and chemical strengthening were sequentially carried out on the glass disk to thereby produce a smooth non-magnetic glass substrate of a chemically strengthened glass disk. The diameter of the disk was 65 mm. The surface roughness of a primary surface of the glass substrate was measured with an atomic force microscope (AFM). As a result, the glass substrate had a smooth surface such that Rmax was 2 nm and Ra was 0.2 nm. Here, Rmax and Ra conform to Japanese Industrial Standards (JIS).

Layers from an adhesive layer to a perpendicular magnetic recording layer of a magnetic recording medium constituent layer were deposited on the obtained glass substrate by a DC magnetron sputtering method using an evacuated deposition apparatus (with the ultimate vacuum of 10⁻⁵ Pa or less).

First, a CrTi layer was formed on each of opposite surfaces of the glass substrate by using a target of 50Cr-50Ti (at % ratio: the same applies hereinafter). The CrTi layer as an adhesive layer on the base surface of the glass substrate had a thickness of 10 nm. The CrTi layer as the nonmagnetic metal film on the secondary surface of the glass substrate opposite to the base surface had a thickness of 30 nm.

Next, only on the base surface of the glass substrate, those layers from the soft magnetic layer to the auxiliary recording layer are formed in the following manner. Specifically, on the adhesive layer, a 92(40Fe-60Co)-3Ta-5Zr layer, a Ru layer, and a 92(40Fe-60Co)-3Ta-5Zr layer were deposited to the thickness of 20 nm, 0.7 nm, and 20 nm, respectively.

Next, a 95Ni-5W layer was deposited to the thickness of 8 nm as a seed layer. Two Ru layers were formed as an underlayer to the thickness of 10 nm each while changing an Ar gas pressure from low pressure to high pressure.

Furthermore, a perpendicular magnetic recording layer was formed thereon. Specifically, a first recording layer of 90(70Co-10Cr-20Pt)-10(Cr₂O₃) was deposited to the thickness of 2 nm. A second recording layer of 90(72Co-10Cr-18Pt)-5(SiO₂)-5(TiO₂) was deposited to the thickness of 12 nm. A magnetic coupling control layer of Ru was deposited to the thickness of 0.3 nm. An auxiliary recording layer of 62Co-18Cr-15Pt-5B was deposited to the thickness of 5.5 nm.

Thereafter, on each of the opposite surfaces of the glass substrate, a carbon-based protective layer was formed of hydrogenated diamond-like carbon by a plasma CVD method using an ethylene gas. Herein, the carbon-based protective layer was formed while applying a bias voltage of −300V. The film thickness of the carbon-based protective layer was 5 nm. Then a lubricating layer was formed of perfluoropolyether (PFPE) by a dip coating method. The film thickness of the lubricating layer was 1 nm.

With the above production steps, a single-sided perpendicular magnetic recording medium of Example 1 was obtained.

### Example 2

A single-sided perpendicular magnetic recording medium of Example 2 was produced in the same manner as in Example 1 except that the film thickness of the CrTi film deposited on the secondary surface of the substrate was 45 nm.

### Example 3

A single-sided perpendicular magnetic recording medium of Example 3 was produced in the same manner as in Example 1 except that the film thickness of the CrTi film deposited on the secondary surface of the substrate was 60 nm.

### Example 4

A single-sided perpendicular magnetic recording medium of Example 4 was produced in the same manner as in Example 1 except that the film thickness of the CrTi film deposited on the secondary surface of the substrate was 5 nm. Bias arc was generated when the carbon-based protective film was formed.

### Example 5

A single-sided perpendicular magnetic recording medium of Example 5 was produced in the same manner as in Example 1 except that the film thickness of the CrTi film deposited on the secondary surface of the substrate was 10 nm.

### Example 6

A single-sided perpendicular magnetic recording medium of Example 6 was produced in the same manner as in Example 1 except that the film thickness of the CrTi film deposited on the secondary surface of the substrate was 20 nm.

### Example 7

A single-sided perpendicular magnetic recording medium of Example 7 was produced in the same manner as in Example 1 except that the film thickness of the CrTi film deposited on the secondary surface of the substrate was 100 nm.

### Example 8

A single-sided perpendicular magnetic recording medium of Example 8 was produced in the same manner as in Example 1 except that the film thickness of the CrTi film deposited on the secondary surface of the substrate was 150 nm.

### Example 9

A single-sided perpendicular magnetic recording medium of Example 9 was produced in the same manner as in Example 1 except that, as the nonmagnetic metal film formed on the secondary surface of the substrate, a Cr film was deposited to the thickness of 30 nm instead of the above-mentioned CrTi film.

### Example 10

A single-sided perpendicular magnetic recording medium of Example 10 was produced in the same manner as in Example 1 except that, as the nonmagnetic metal film formed on the secondary surface of the substrate, a Ti film was deposited to the thickness of 30 nm instead of the above-mentioned CrTi film.

### Example 11

A single-sided perpendicular magnetic recording medium of Example 11 was produced in the same manner as in Example 1 except that, as the nonmagnetic metal film formed on the secondary surface of the substrate, a Ta film was deposited to the thickness of 30 nm instead of the above-mentioned CrTi film.

### Example 12

A single-sided perpendicular magnetic recording medium of Example 12 was produced in the same manner as in Example 1 except that, as the nonmagnetic metal film formed on the secondary surface of the substrate, a W film was deposited to the thickness of 30 nm instead of the above-mentioned CrTi film.

### Example 13

A single-sided perpendicular magnetic recording medium of Example 13 was produced in the same manner as in Example 1 except that, as the nonmagnetic metal film formed on the secondary surface of the substrate, a Mo film was deposited to the thickness of 30 nm instead of the above-mentioned CrTi film.

### Example 14

A single-sided perpendicular magnetic recording medium of Example 14 was produced in the same manner as in Example 1 except that, as the nonmagnetic metal film formed on the secondary surface of the substrate, a 50Cr-50Mo film was deposited to the thickness of 30 nm instead of the above-mentioned CrTi film.

### Example 15

A single-sided perpendicular magnetic recording medium of Example 15 was produced in the same manner as in Example 1 except that, as the nonmagnetic metal film formed on the secondary surface of the substrate, a 50Cr-50Ta film was deposited to the thickness of 30 nm instead of the above-mentioned CrTi film.

### Comparative Example 1

A single-sided perpendicular magnetic recording medium of Comparative Example 1 was produced in the same manner as in Example 1 except that no thin film was deposited on the secondary surface of the substrate.

### Comparative Example 2

A single-sided perpendicular magnetic recording medium of

Comparative Example 2 was produced in the same manner as in Example 1 except that only the same carbon-based protective film as in Example 1 was deposited on the secondary surface of the substrate. There was a problem that bias arc was generated when the carbon-based protective film was formed,

### Reference Example

The same magnetic recording medium constituent layer as that formed on the base surface was formed on the secondary surface of the substrate. Thus, a double-sided perpendicular magnetic recording medium was produced.

The following evaluations were performed on the perpendicular magnetic recording media of the above examples, comparative examples, and reference example.

Evaluation of Magnetic Characteristics

The magnetic characteristics was evaluated with a perpendicular magnetic characteristic Kerr effect measurement apparatus (Model-32kt Gauss Meter of KLA-Tencor Corporation). Table 1 shows the magnetic coercive force Hc, the nucleus growth magnetic field Hn, and the difference ΔHc of the magnetic coercive forces Hc and the difference ΔHn of the nucleus growth magnetic fields Hn from those of the medium in Reference Example. The units of the magnetic characteristics listed in Table 1 are all represented by oersted [Oe]. Those characteristics were results for the primary surface (base surface).

TABLE 1

| | Film thickness of | | | | |
|---|---|---|---|---|---|
| | non-magnetic metal | | | | |
| | film [nm] | Hc | Hn | ΔHc | ΔHn |
| Reference Example | — | 5359 | −2682 | — | — |
| Example 1 | 30 | 5222 | −2702 | 137 | 20 |
| Example 2 | 45 | 5287 | −2878 | 72 | 196 |
| Example 3 | 60 | 5358 | −2834 | 1 | 152 |
| Example 4 | 5 | 5139 | −2311 | 220 | −371 |
| Example 5 | 10 | 5196 | −2543 | 163 | −139 |
| Example 6 | 20 | 5218 | −2621 | 141 | −61 |
| Example 7 | 100 | 5234 | −2744 | 125 | 62 |
| Example 8 | 150 | 4963 | −2257 | 396 | −425 |
| Example 9 | 30 | 5215 | −2655 | 144 | −27 |
| Example 10 | 30 | 5241 | −2730 | 118 | 48 |
| Example 11 | 30 | 5260 | −2741 | 99 | 59 |
| Example 12 | 30 | 5236 | −2695 | 123 | 13 |
| Example 13 | 30 | 5231 | −2668 | 128 | −14 |
| Example 14 | 30 | 5233 | −2663 | 126 | −19 |
| Example 15 | 30 | 5211 | −2677 | 148 | −5 |
| Comparative | 0 | 5132 | −3173 | 227 | 491 |
| Example 1 | | | | | |
| Comparative | 0 | 5086 | −2076 | 273 | −606 |
| Example 2 | | | | | |

Evaluation of Reliability

The reliability was evaluated with a corrosion spot test in which the media were left under an atmospheric pressure at a temperature of 90° C. and a humidity of 90% for 3 days. The corrosion spot test was conducted with OSA6100 of KLA-Tencor Corporation. Table 2 shows the numbers of spot counts (unit: counts/mm²). Those were results for the base surface (primary surface).

TABLE 2

| | Film thickness of | |
|---|---|---|
| | non-magnetic metal film | Spot counts |
| Reference Example | — | 1.0 × 10⁻² |
| Example 1 | 30 | 1.7 × 10⁻³ |
| Example 2 | 45 | 8.4 × 10⁻⁴ |
| Example 3 | 60 | 1.3 × 10⁻³ |
| Example 4 | 5 | 9.7 × 10⁻³ |
| Example 5 | 10 | 2.0 × 10⁻³ |
| Example 6 | 20 | 1.9 × 10⁻³ |
| Example 7 | 100 | 1.0 × 10⁻³ |
| Example 8 | 150 | 0.9 × 10⁻³ |
| Example 9 | 30 | 3.0 × 10⁻³ |
| Example 10 | 30 | 4.7 × 10⁻³ |
| Example 11 | 30 | 5.3 × 10⁻³ |
| Example 12 | 30 | 5.8 × 10⁻³ |
| Example 13 | 30 | 6.0 × 10⁻³ |
| Example 14 | 30 | 2.3 × 10⁻³ |
| Example 15 | 30 | 1.5 × 10⁻³ |
| Comparative Example 1 | 0 | >10⁴ |
| Comparative Example 2 | 0 | >10⁴ |

Evaluation of Flatness

The flatness of the media (warping of substrates) was evaluated with an optical flat apparatus for evaluation of Newton's rings. Table 3 shows average values.

TABLE 3

| | |
|---|---|
| Film thickness of | |
| non-magnetic metal film | |
| [nm] | Flatness |

| | | |
|---|---|---|
| Reference Example | — | 0.294 |
| Example 1 | 30 | 0.007 |
| Example 2 | 45 | 0.007 |
| Example 3 | 60 | 0.171 |
| Example 4 | 5 | 0.860 |
| Example 5 | 10 | 0.033 |
| Example 6 | 20 | 0.015 |
| Example 7 | 100 | 0.357 |
| Example 8 | 150 | 0.528 |
| Example 9 | 30 | 0.009 |
| Example 10 | 30 | 0.011 |
| Example 11 | 30 | 0.014 |
| Example 12 | 30 | 0.023 |
| Example 13 | 30 | 0.021 |
| Example 14 | 30 | 0.009 |
| Example 15 | 30 | 0.007 |
| Comparative Example 1 | 0 | 2.120 |
| Comparative Example 2 | 0 | 12.507 |

It can be seen from the results of evaluation of the magnetic characteristics shown in Table 1 that a single-sided magnetic recording medium can have magnetic characteristics that are almost equivalent to a conventional double-sided magnetic recording medium when a CrTi film, for example, is formed as a non-magnetic metal film on a secondary surface of a substrate. Particularly, when the film thickness of the CrTi film is set to be in a range of 10 nm to 100 nm, the magnetic coercive force Hc becomes equivalent to that of a double-sided magnetic recording medium. Furthermore, Hn can suitably be made equal to or less than −2,400 Oe. Moreover, the difference ΔHc of the magnetic coercive force Hc from that of a double-sided magnetic recording medium can suitably be made equal to or less than 200 Oe. The difference ΔHn of Hn from that of a double-sided magnetic recording medium can suitably be made equal to or less than 300 Oe.

Furthermore, it can be seen from the results of evaluation of the reliability shown in Table 2 that the number of corrosion spots drastically decreased when a CrTi film was formed as a non-magnetic metal film with a thickness of 10 nm to 100 nm on the secondary surface of the substrate. This is because, by covering the secondary surface of the substrate and its ends with the CrTi film, Co of a material containing Co or alkali metals contained in the glass substrate became unlikely to be ionized even in a high-temperature high-humidity environment and consequently became unlikely to be exposed on the primary surface of the substrate. It is noted here that ion of Co or alkali metals may possibly migrate from an end face or an opposite surface to be exposed on the base surface (primary surface).

As described above, a single-sided magnetic recording medium according to the present invention can exhibit high reliability even in an environment having a high temperature and a high humidity.

As can be seen from the results of evaluation of the flatness shown in Table 3, when a CrTi film, for example, is formed as a non-magnetic metal film on the secondary surface of the substrate, the flatness can be improved to a large degree, so that warping of a substrate can be almost eliminated.

As described above, when a CrTi film, for example, is formed as a non-magnetic metal film with a thickness of 10 nm to 100 nm on the secondary surface of the substrate, excellent results can be obtained with respect to evaluations of the magnetic characteristics, the reliability, and the flatness. Particularly, when the film thickness of the CrTi film is in a range of 30 nm to 60 nm, better results can be obtained.

The same evaluations as described above were performed on single-sided perpendicular magnetic recording media of Examples 9 to 15 produced in the same manner as in Example 1 except that a Cr film, a Ti film, a Ta film, a W film, a Mo film, a 50Cr-50Mo film, or a 50Cr-50Ta film (having a film thickness of 30 nm) was used as a non-magnetic metal film formed on the secondary surface of the substrate instead of the CrTi film. As shown in Tables 1 to 3, all of those media exhibited excellent results according to the present invention,

Additionally, on the secondary surface, elution of glass components from a glass substrate was examined by means of corrosion spots. No glass components were eluted from a glass substrate in the magnetic recording media of the aforementioned examples. On the other hand, glass components were eluted in the magnetic recording media of the comparative examples.

Specifically, a single-sided perpendicular magnetic recording medium in which a non-magnetic metal film and a carbon-based protective film are formed on a secondary surface of a substrate can exhibit magnetic characteristics and reliability characteristics that are almost equivalent to those of conventional double-sided media. Therefore, it is possible to provide a perpendicular magnetic recording medium that can lessen warping of a substrate and can remarkably reduce the cost.

Although certain preferred embodiments of the present invention have been shown and described in detail, it should be understood that various changes and modifications may be made therein without departing from the scope of the appended claims.

What is claimed is:

1. A magnetic recording medium used for perpendicular magnetic recording, the magnetic recording medium comprising:
a substrate having a first surface and a second surface opposite to the first surface;
a magnetic recording medium constituent layer formed on the first surface of the substrate, the magnetic recording medium constituent layer including at least a magnetic recording layer;
a non-magnetic metal film formed on the second surface of the substrate; and
a carbon-based protective film formed on the non-magnetic metal film.

2. The magnetic recording medium according to claim 1, wherein the non-magnetic metal film is formed of a material containing, as a principal component, one element of Cr, Ti, Ta, W, Mo, and Al or a compound of two or more elements of Cr, Ti, Ta, W, Mo, and Al.

3. The magnetic recording medium according to claim 1, wherein the non-magnetic metal film has a film thickness in a range of from 10 nm to 100 nm.

4. The magnetic recording medium according to claim 1, wherein the carbon-based protective film comprises a diamond-like carbon film.

5. A single-sided perpendicular magnetic recording medium according to claim 1, wherein the substrate is a glass substrate.

6. The magnetic recording medium according to claim 1, wherein the magnetic recording layer includes a ferromagnetic layer having a granular structure which includes crystal grains mainly formed by cobalt (Co) and boundaries mainly formed by oxides.
